(19) United States
(12) Patent Application Publication
(10) Pub. No.: US 2025/0242850 A1
(43) Pub. Date: Jul. 31, 2025

(54) STROLLER FRAME

(71) Applicant: Wonderland Switzerland AG, Steinhausen (CH)

(72) Inventor: Haitao WU, Dongguan, Guangdong (CN)

(73) Assignee: Wonderland Switzerland AG, Steinhausen (CH)

(21) Appl. No.: 18/845,829

(22) PCT Filed: Mar. 10, 2023
(86) PCT No.: PCT/EP2023/056220

§ 371 Date: Sep. 10, 2024

(30) Foreign Application Priority Data
Mar. 10, 2022 (CN) 202210233367.2
Sep. 30, 2022 (CN) 202211216655.3

(51) Int. Cl. B62B 7/10; B62B 7/06

(52) U.S. Cl. CPC B62B 7/105; B62B 7/064

(57) ABSTRACT

The present disclosure relates to a frame, which includes two base support rods, two handle support rods, a first support assembly and a second support assembly. The second support assembly is U-shaped and includes a second cross rod portion. The second cross rod portion is set in a left-right direction of the frame. The first support assembly is connected to the second cross rod portion. The first support assembly and the second support assembly are connected between two base support rods and two handle support rods.

### CROSS-REFERENCE TO RELATED APPLICATIONS

This application is an U.S. national phase application under 35 U.S.C. § 371 based upon International Patent Application No. PCT/EP2023/056220, filed on Mar. 10, 2023, which itself claims priority to Chinese Patent Application No. 2022112166553, filed on Sep. 30, 2022, and Chinese Patent Application No. 2022102333672, filed on Mar. 10, 2022. The contents of the above identified applications are hereby incorporated herein in their entireties by reference.

### TECHNICAL FIELD

The present disclosure relates to the technical field of baby carriers, in particular to a frame.

### BACKGROUND

In a baby vehicle, such as a stroller, a frame is usually connected between the handle and the base bracket by two foldable straight support rods. However, in this frame, since the overall support structure mainly relies on the point contact between the two ends of the straight support rod with the handle and the base bracket, thus the support is unstable and the shaking is significant.

### SUMMARY

The present disclosure provides a frame which includes two base support rods, two handle support rods, a first support assembly, and a second support assembly. The second support assembly is U-shaped, and includes a second cross rod portion. The second cross rod portion is disposed along a left-right direction of the frame, and the first support assembly is connected to the second cross rod portion. The first support assembly and the second support assembly are connected between two base support rods and two handle support rods.

In an embodiment, the first support assembly is rotatably connected to the second cross rod portion of the second support assembly.

In an embodiment, the first support assembly is pivotably connected to the two base support rods, and the second support assembly is pivotably connected to the two handle support rods.

In an embodiment, the first support assembly is U-shaped, the first support assembly includes a first cross rod portion, the first cross rod portion is connected to the second cross rod portion and both arranged in a left-right direction of the frame.

In an embodiment, the first cross rod portion is rotatably connected to the second cross rod portion.

In an embodiment, the frame further includes a connection member sleeved outside the first cross rod portion and the second cross rod portion. The first cross rod portion is fixedly connected to the connection member, and the second cross rod portion is rotatable relative to the connection member.

In an embodiment, the connection member includes a first sleeve portion and a plurality of second sleeve portions. The plurality of second sleeve portions are provided at intervals and are connected to the first sleeve portion, the first sleeve portion is sleeved outside the first cross rod portion, and the plurality of second sleeve portions are sleeved outside the second cross rod portion.

In an embodiment, the frame further includes an guide member. The guide member is located between two adjacent second sleeve portions. The guide member is fixedly connected to the second cross rod portion. The guide member has a first limit surface and a second limit surface. The connection member has a first abutting surface and a second abutting surface. The first abutting surface and the second abutting surface are both located on the first sleeve portion. When the frame is in a fully unfolded state, the first limit surface abuts against the first abutting surface. When the frame is in a fully folded state, the second limit surface abut against the second abutting surface.

In an embodiment, the frame further includes an guide member located between the two adjacent second sleeve portions. The guide member is fixedly connected to the second cross rod portion. The guide member has a first guide surface and a second guide surface. The connection member has a third abutting surface and a fourth abutting surface. The third abutting surface and the fourth abutting surface are two opposing surfaces of the two adjacent second sleeve portions respectively. During a rotation of the second cross rod portion, the first guide surface is kept abutting against the third abutting surface, and the second guide surface is kept abutting against the fourth abutting surface.

In an embodiment, the first support assembly includes two first support members, and the two first support members are connected to two ends of the second cross rod portion respectively.

In an embodiment, the two first support members are rotatably connected to the two ends of the second cross rod portion respectively.

In an embodiment, the first support member includes a first support rod and a sleeve member. The sleeve member is fixedly connected to the first support rod, and the sleeve member is sleeved outside the second cross rod portion.

In an embodiment, the first support member includes a first support rod and a sleeve member. The sleeve member is fixedly connected to the first support rod, and the second cross rod portion is rotatable relative to the sleeve member.

In an embodiment, the second support assembly further includes two second support members fixed to two ends of the second cross rod portion.

In an embodiment, each of the two second support member includes a first insertion portion, and the first insertion portions of the two second support members are at least partially inserted into the two sleeve members respectively.

In an embodiment, the second cross rod portion includes a support portion and two second insertion portions. Two ends of the support portion are connected to the two second insertion portions respectively, and the two second insertion portions are at least partially inserted in the two sleeve members and sleeved outside the two first insertion portions.

In an embodiment, an outer radial dimension of the support portion is greater than an outer radial dimension of any of the second insertion portions.

In an embodiment, the second support assembly further includes a fastener that fixedly connects the first insertion portion to the support portion of the second cross rod portion.

In an embodiment, the second support member further includes a second support rod being L-shaped and including a first rod and a second rod which are connected to each other and arranged at a certain angle. An end of the first rod away from the second rod is connected to the first insertion portion, and an outer radial dimension of the first rod is larger than an outer radial dimension of the first insertion portion.

In an embodiment, the frame further includes a first limit member and a second limit member. The first limit member is connected to the first support assembly. The second limit member is connected to the base support rod. In a process of switching the frame from a fully folded state to a fully unfolded state, the first support assembly rotates in a first direction, and the second support assembly rotates in a second direction opposite to the first direction, such that the first support assembly and the second support assembly are away from each other. When the frame is switched to a fully unfolded state, the first limit member is engaged with the second limit member to restrict the first support assembly from rotating in the first direction.

In an embodiment, one of the first limit member and the second limit member has a limit recess, and the other of the first limit member and the second limit member is a limit projection that is engageable with the limit recess.

In an embodiment, the frame further includes a linking member and a wheel fixing member. The wheel fixing member is connected to the base support rod. One end of the first limit member is fixedly connected to the first support assembly, another end of the first limit member is pivotably connected to one end of the linking member, and another end of the linking member is pivotably connected to the wheel fixing member.

In an embodiment, the frame further includes a first limit member and a second limit portion. The first limit member is connected to the first support assembly. The second limit portion is connected to the base support rod. In a process of switching the frame from a fully folded state to a fully unfolded state, the first support assembly rotates in a first direction, and the second support assembly rotates in a second direction opposite to the first direction, such that the first support assembly and the second support assembly are away from each other. When the frame is switched to the fully unfolded state, the first limit member is engaged with the second limit portion to restrict the first support assembly from rotating in the first direction.

In an embodiment, the first limit member has a limit projection, and the second limit portion is a limit recess provided on the base support rod; or, the first limit member has a limit recess, and the second limit portion is a limit projection provided on the base support rod.

In an embodiment, the first support assembly is connected to the two base support rods, and two ends of the second support assembly are connected to the two handle support rods respectively; or, the first support assembly is connected to the two handle support rods, and two ends of the second support assembly are connected to the two base support rods respectively.

In an embodiment, the frame further includes a seat plate, two backrest support rods and two connecting rods. The two connecting rods are connected to the two backrest support rods respectively, and two sides of the seat plate are fixed on the two connecting rods or the two backrest support rods respectively.

In an embodiment, the frame further includes a seat plate which abutting against a top of the first support assembly.

In an embodiment, the handle support rod includes a first handle portion and a second handle portion which are pivotably connected to each other. An end of the first handle portion away from the second handle portion is fixed to the base support rod, and the two ends of the second support assembly are pivotably connected to the second handle portions of the two handles support rods respectively.

### BRIEF DESCRIPTION OF THE DRAWINGS

FIG. 1 is a schematic diagram of a frame according to a first embodiment of the present disclosure.

FIG. 2 is a partial schematic view of the frame as shown in FIG. 1, where the frame is in a fully unfolded state.

FIG. 3 is a schematic diagram of a first support assembly, a second support assembly, a connection member and an guide member in the frame shown in FIG. 2.

FIG. 4 is a sectional view along a line A-A shown in FIG. 3.

FIG. 5 is a schematic diagram of FIG. 3 in another perspective.

FIG. 6 is a partial schematic view of the frame as shown in FIG. 1, where the frame is in a half-folded state.

FIG. 7 is an enlarged view of a portion B in FIG. 6.

FIG. 8 is a schematic diagram of FIG. 6 in another perspective, where the frame is in the half-folded state.

FIG. 9 is an enlarged view of a portion C in FIG. 8.

FIG. 10 is a partial schematic diagram of the frame as shown in FIG. 1, where the frame is in the half-folded state.

FIG. 11 is an enlarged diagram of a portion D in FIG. 10.

FIG. 12 is a partial schematic diagram of FIG. 10 in another perspective, where the frame is in a fully folded state.

FIG. 13 is an enlarged diagram of a portion E in FIG. 12.

FIG. 14 is a partial schematic diagram of the frame according to a second embodiment of the present disclosure, where the frame is in a fully unfolded state.

FIG. 15 is a schematic diagram of a first support assembly, a second support assembly, and a limit member in the frame shown in FIG. 14.

FIG. 16 is an exploded view of FIG. 15.

FIG. 17 is another exploded view of FIG. 15.

FIG. 18 is a cross-sectional view of FIG. 15.

FIG. 19 is an enlarged view of a portion H in FIG. 18.

FIG. 20 is a partial schematic view of the frame as shown in FIG. 14, where the frame is in a fully unfolded state.

FIG. 21 is an enlarged view of a portion F in FIG. 20.

FIG. 22 is a schematic diagram of the structure shown in FIG. 21 in another perspective.

FIG. 23 is a partial schematic view of the frame as shown in FIG. 14, where the frame is in a half-folded state.

FIG. 24 is an enlarged view of a portion G in FIG. 23.

FIG. 25 is a schematic diagram of a first support assembly, a second support assembly and a limit member in the frame shown in FIG. 23.

### Description of Reference Numerals

100: base bracket; 110: base support rod;
200: wheel assembly; 210: wheel body; 220: wheel fixing member; 300: handle; 310: handle body; 320: handle support rod; 321: first handle portion; 322: second handle portion;
400: backrest; 410: backrest body; 420: backrest support rod;
500: first support assembly; 510: first cross rod portion; 520: first connecting portion; 530: first support member; 531: first support rod; 5311: straight rod section; 5312: arc-shaped rod section; 532: sleeve member; 5321: first sleeve cylinder; 5322: second sleeve cylinder; 5323: first stop end surface; 5324: second stop end surface;
600: second support assembly; 610: second cross rod portion; 611: second insertion portion; 612: support portion; 6121: fourth stop end face; 620: second connection portion; 630: second support member; 631: second support rod; 6311: first rod; 6312: second rod; 6313: third stop end surface; 632: first insertion portion;
710: seat plate; 720: connecting rod;
800: connection member; 810: first sleeve portion; 811: first abutting surface; 812: second abutting surface; 820: second sleeve portion; 821: third abutting surface; 822: fourth abutting surface; 830: sleeve space;
910: guide member; 911: first limit surface; 912: second limit surface; 913: first guide surface; 914: second guide surface; 920: limit assembly; 921: first limit member; 9211: limit projection; 9212: fixing sleeve cylinder; 922: second limit member; 9221: limit recess; 923: linking member; and 930: fastener.

### DETAILED DESCRIPTION OF THE EMBODIMENTS

In order to make the objectives, technical solutions and advantages of the present disclosure clearer, the present disclosure will be further described in detail below with reference to the accompanying drawings and specific embodiments. It should be understood that the specific embodiments described herein are only used to explain the present disclosure, and do not limit the protection scope of the present disclosure.

When an assembly is considered to be “connected” to another assembly, it can be connected directly to another assembly or it may exist simultaneously as an intermediate assembly. The terms “vertical”, “horizontal”, “left”, “right”, and the like used herein are for illustrative purposes only and are not intended to be the only embodiment.

All technical and scientific terms used herein have the same meaning as commonly understood by skilled person in the art to which the present disclosure belongs, unless otherwise defined. The terms used in the specification of the present invention herein are for the purpose of describing specific examples only and are not intended to restrict the present invention. The term “and/or” used herein includes any and all combinations of one or more of the associated listed objects.

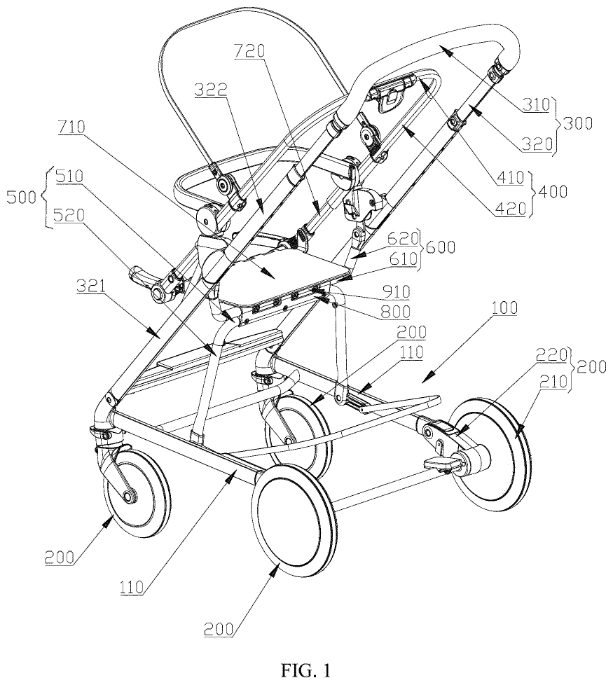

As shown in FIG. 1, an embodiment of the present disclosure provides a frame, which includes a base bracket 100, a wheel assembly 200, a handle 300, a backrest 400, a first support assembly 500, a second support assembly 600, a seat plate 710 and a connecting rod 720. The frame is capable of providing stable support, and the overall structure is not easy to shake, which provides a good riding experience.

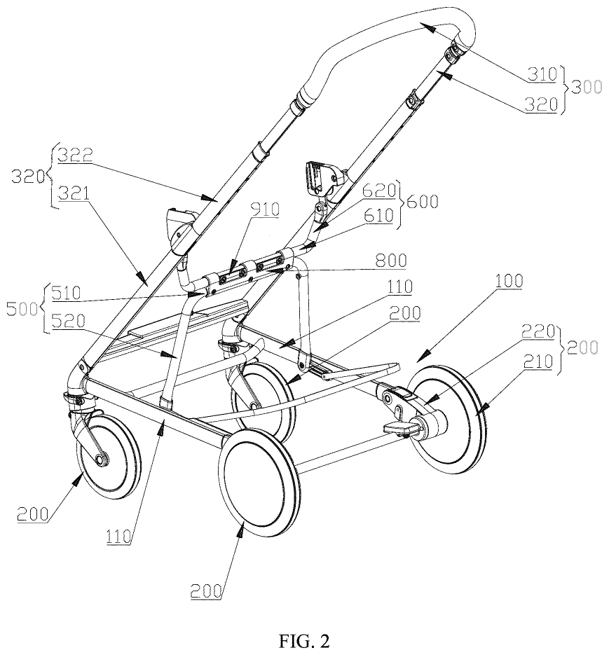

Further, as shown in FIG. 2, the base bracket 100 has two base support rods 110 parallel to each other. There are four wheel assemblies 200, two of which are first wheel assemblies 200 and two of which are second wheel assemblies 200. Two ends of each base support rod 110 are connected to a front wheel assembly 200 and a rear wheel assembly 200 respectively. Each wheel assembly 200 includes a wheel fixing member 220 connected to the base bracket 100 and a wheel body 210 rotatably connected to the wheel fixing member 220.

Specifically, as shown in FIG. 1, the handle 300 includes a handle body 310 and two handle support rod 320 connected to two ends of the handle body 310. Each handle support rod 320 includes a first handle portion 321 and a second handle portion 322 that are pivotably connected to each other, and an end of the first handle portion 321 away from the second handle portion 322 is fixed to the base support rod 110. If an external force is applied to the handle body 310, the second handle portion 322 is caused to be folded relative to the first handle portion 321.

Specifically, as shown in FIG. 1, the backrest 400 includes the backrest body 410 and two backrest support rods 420 connected to two ends of the backrest body 410. The two backrest support rods 420 are fixed to two handle support rods 320 respectively.

Specifically, as shown in FIG. 2, the second support assembly 600 has an overall U-shaped rod structure, and the second support assembly 600 has a second cross rod portion 610 arranged in a left-right direction of the frame. The first support assembly 500 is rotatably connected to the second cross rod portion 610. The first support assembly 500 is pivotably connected to an inner side of the two base support rods 110 (i.e. the opposing sides of the two base support rods 110) and two ends of the second support assembly 600 are pivotably connected to the inner side of the two handle support rods 320 (i.e. the opposing sides of the two handle support rods 320). Alternatively, the first support assembly 500 may be pivotably connected to the two handle support rods 320 and the two ends of the second support assembly 600 may be pivotably connected to the two base support rod 110 respectively. Alternatively, the first support assembly 500 may be pivotably connected to an outer side or other locations of the base support rod 110, and the second support assembly 600 may be pivotably connected to the outer side or other locations of the handle support rod 320. This enables a rotatable connection between the first support assembly 500 and the second support assembly 600, allowing the frame to be folded as a whole.

Of course, in frames that do not require a folding function, there can also be a fixing connection between the first support assembly 500 and the second cross rod portion 610, between the first support assembly 500 and the two base support rod 110 (or the handle support rod 320), and between two ends of the second support assembly 600 and the two handle support rods 320 (or the base support rod 110).

Optionally, as shown in FIG. 1, the two connecting rods 720 are connected to the bottom ends of the two backrest support rods 420 respectively, and the two sides of the seat plate 710 are connected to the two connecting rods 720, respectively. In this embodiment, the connecting rod 720 and the backrest support rod 420 are different rods, and of course, in other embodiments, the connecting rod 720 and the backrest support rod 420 may also be the same rod. The frame may also include a seat cloth (not shown in the drawings) sleeved on the backrest 400, with the seat plate 710 located within the seat cloth. Alternatively, in another embodiment, two sides of the seat plate 710 may be connected to two backrest support rods 420 respectively and supported by a seat cloth (sleeved on the seat plate 410 and backrest 400. In another embodiment, a front side of the seat plate 710 is connected to bottom ends of the two backrest support rods 420 respectively, and a rear side of the seat plate 710 abuts against the second cross rod portion 610, i.e. the second cross rod portion 610 provides support for the seat plate 710. The arranging method of seat plate 710 is not limited to the aforementioned method, and can be set to other forms as needed.

Specifically, the structures of the first support assembly 500 and the second support assembly 600 may be in various forms. For example, in the first embodiment, the specific structures of the first support assembly 500 and the second support assembly 600 may both be provided with U-shaped rods. As shown in FIG. 2, the first support assembly 500 includes the first cross rod portion 510 and two first connecting portions 520 connected to two ends of the first cross rod portion 510. Ends of the two first connecting portions 520 away from the first cross rod portion 510, are pivotably connected to the two base support rods 110 respectively. In addition to the second cross rod portion 610 mentioned above, the second support assembly 600 includes two second cross rod portions 610 connected to two ends of the second cross rod portion 610. Ends of the two second cross rod portions 610 away from the second cross rod portion 610 are pivotably connected to the two handle support rods 320 respectively. The first cross rod portion 510 is pivotably connected to the second cross rod portion 610. Thus, the two ends of first support assembly 500 are pivotably connected to the base support rod 110, and the two ends of the second support assembly 600 are pivotably connected to the handle support rod 320. Meanwhile, the first support assembly 500 and the second support assembly 600 are pivotably connected by the first cross rod portion 510 and the second cross rod portion 610 respectively, that is, the pivoting connection between the first support assembly 500 and the second support assembly 600 is line connection, such that the overall structure has good stability.

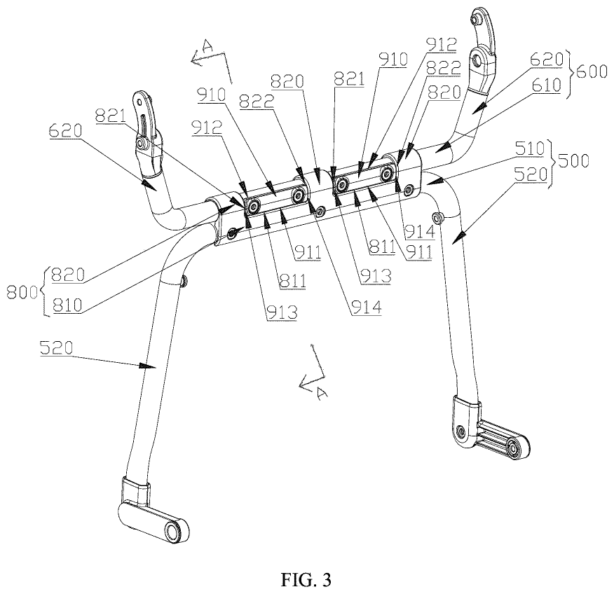

Further, as shown in FIG. 3, the frame of this embodiment further includes a connection member 800. The connection member 800 is sleeved outside the first cross rod portion 510 and the second cross rod portion 610, the first cross rod portion 510 is fixedly connected to the connection member 800, and the second cross rod portion 610 is rotatable relative to the connection member 800. Of course, in other embodiments, the second cross rod portion 610 may be fixedly connected to the connection member 800, and the first cross rod portion 510 may rotate relative to the connection member 800.

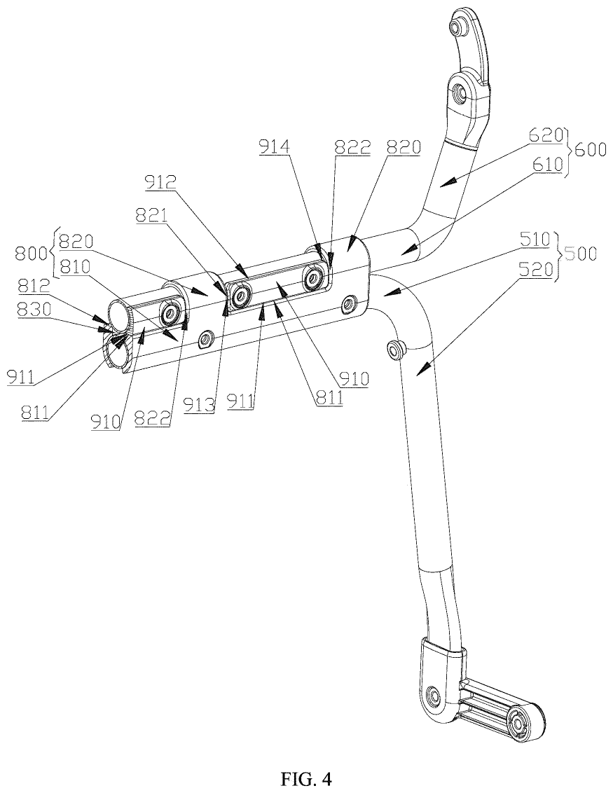

Specifically, as shown in FIGS. 3 and 4, the connection member 800 includes a first sleeve portion 810 and three second sleeve portions 820. The three second sleeve portions 820 are arranged at intervals and all connected to the first sleeve portion 810. Of course, in other embodiments, the number of second sleeve portions 820 may be more or less than three depending on actual needs. The first sleeve portion 810 and three second sleeve portions 820 enclose a sleeve space 830 (as shown in FIG. 4). Both the first cross rod portion 510 and the second cross rod portion 610 are located within the sleeve space 830. The first sleeve portion 810 is sleeved on the first cross rod portion 510, and the second sleeve portion 820 is fixed on the second cross rod portion 610. In this embodiment, the first sleeve portion 810 is fixed to the first cross rod portion 510 via three rivets arranged at intervals. Of course, in other embodiments, the first sleeve portion 810 may be fixed to the first cross rod portion 510 by other means such as welding or the like. The three second sleeve portions 820 are sleeved outside the second cross rod portion 610. The second cross rod portion 610 is capable of being rotated with respect to second sleeve portion 820, that is, with respect to connection member 800. This enables a rotatable connection between the first support assembly 500 and the second support assembly 600 via the connection member 800.

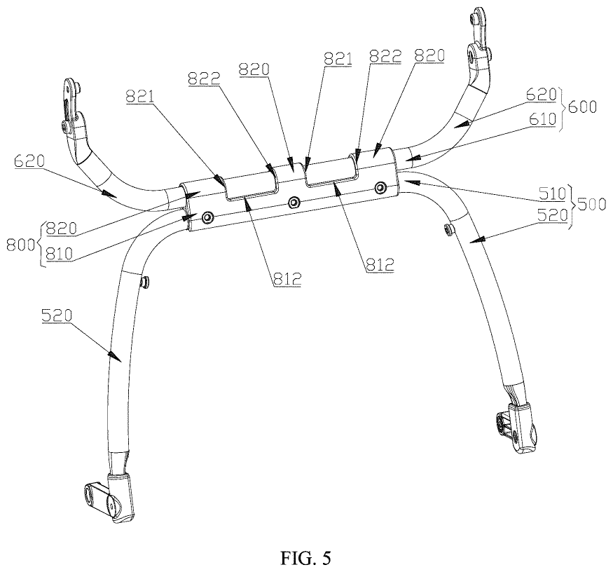

Further, as shown in FIGS. 3 to 5, the first sleeve portion 810 has a first abutting surface 811 and a second abutting surface 812, both of which are located between two adjacent second sleeve portions 820. The opposing surfaces of the two adjacent second sleeve portion 820 are the third abutting surface 821 and the fourth abutting surface 822, respectively.

As shown in FIG. 3, the frame of this embodiment may further include a guide member 910. In this embodiment, there are two guide members 910, and one guide member 910 is arranged between every two second sleeve portions 820. Of course, in other embodiments, the number and the arranging mode of the guide member 910 can also be adjusted as needed. The guide member 910 has a substantially rectangular plate structure. The guide member 910 is fixed to the second cross rod portion 610. In this embodiment, the guide member 910 is fixed to the second cross rod portion 610 by rivets. Of course, in other embodiments, the guide member 910 may be fixed to the second cross rod portion 610 by other means, such as welding or the like.

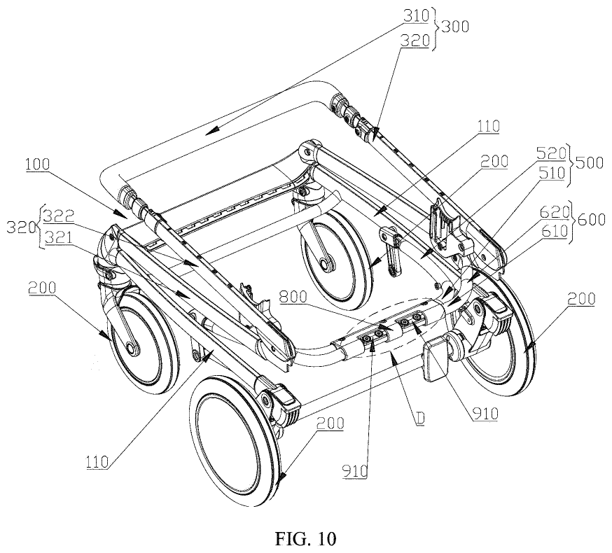

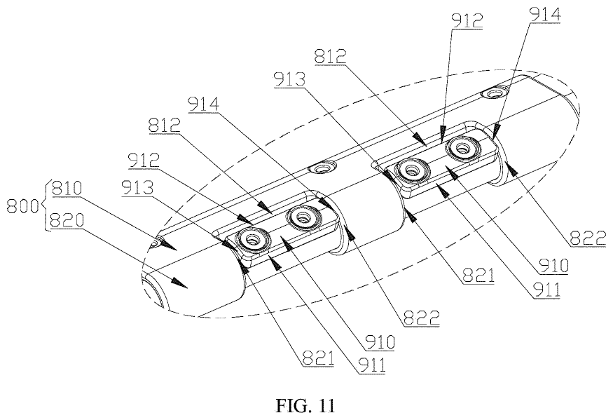

Further, as shown in FIG. 3 and FIG. 4, the guide member 910 has a first limit surface 911 and a second limit surface 912. As shown in FIG. 2 and FIG. 3, when the frame is in a fully unfolded state, the first limit surface 911 abuts against the first abutting surface 811. As shown in FIG. 10 and FIG. 11, when the frame is in a fully folded state, the second limit surface 912 abuts against the second abutting surface 812. In this way, a rotation angle of the second support assembly 600 relative to the first support assembly 500 is limited, allowing the frame to fold and unfold within a controllable angle.

Further, as shown in FIG. 3 and FIG. 4, the guide member 910 has a first guide surface 913 and a second guide surface 914. The first guide surface 913 and the second guide surface 914 are provided in a rotation direction of the second cross rod portion 610, and during a rotation of the second cross rod portion 610, the first guide surface 913 is kept abutting against the third abutting surface 821, and the second guide surface 914 is kept abutting against the fourth abutting surface 822. In this way, the guide member 910 can act a guiding function and a limiting function for the rotation of the second cross rod portion 610. That is, the second cross rod portion 610 can be rotated in a predetermined direction to prevent the second cross rod portion 610 from shaking in a left-right direction due to the gap between the second cross rod portion 610 and the connection member 800. In this way, the structure stability of the frame can be further improved. Of course, the guide member 910 may also be part of the second cross rod portion 610, i.e. the guide member 910 is integrated with the second support assembly 600.

In this embodiment, the folding and unfolding process of the frame is as follows.

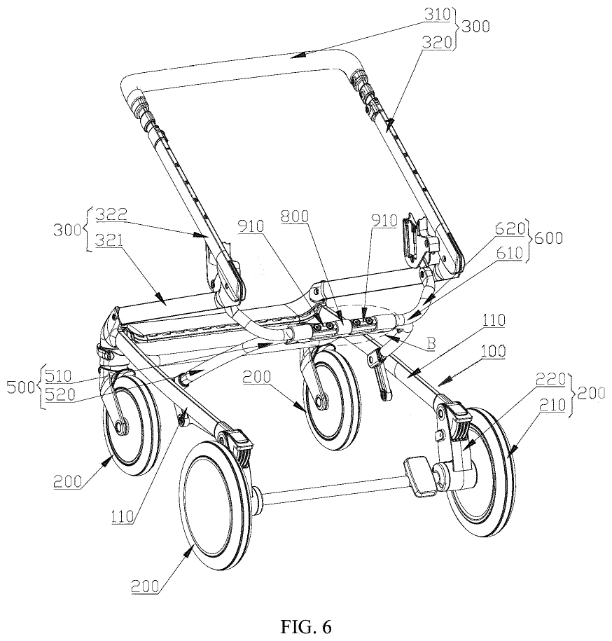

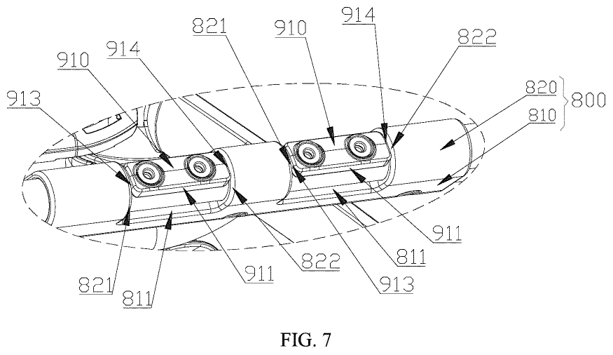

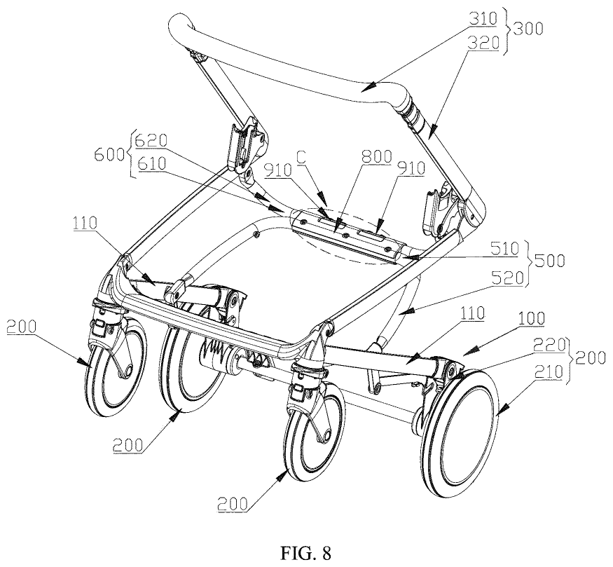

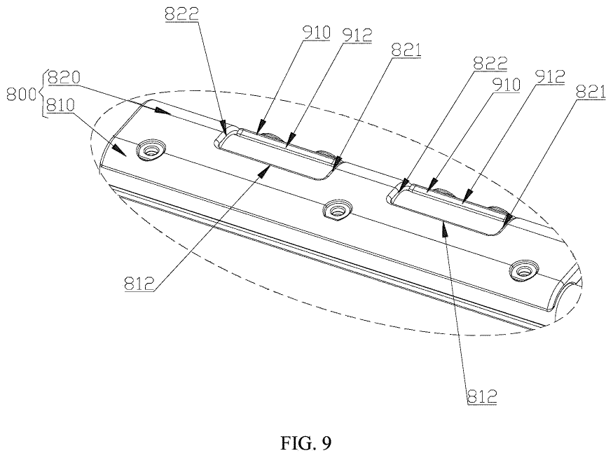

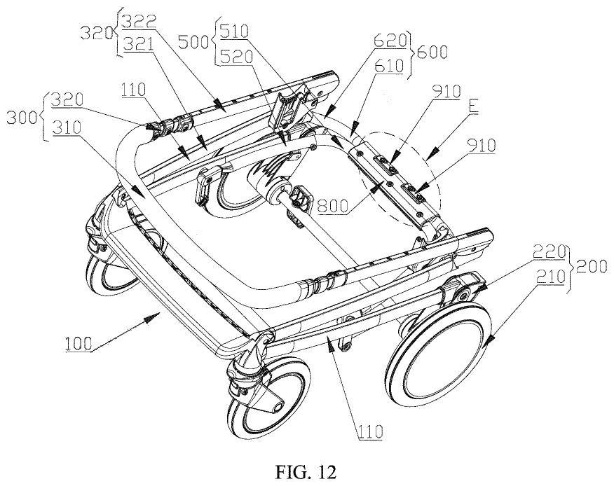

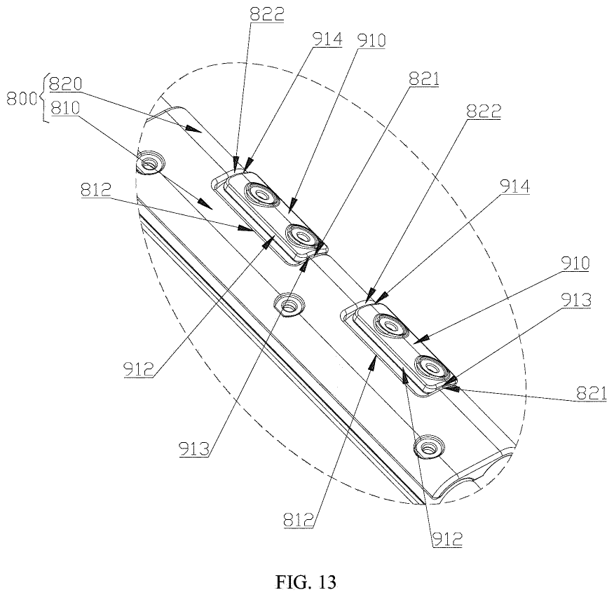

As shown in FIG. 2 and FIG. 3, when the frame needs to be folded, an external force is applied to the handle body 310 such that the handle support rod 320 is bent. As shown in FIGS. 6 to 9, the first handle portion 321 and the second handle portion 322 are pivotably folded in a direction close to each other. The pivoting of the second handle portion 322 drives the second support assembly 600 to rotate. The first support assembly 500 and the second support assembly 600 are pivotably folded in a direction close to each other, and the guide member 910 is rotated from the first limit surface 911 abutting against the first abutting surface 811 to the second limit surface 912 abutting against the second abutting surface 812. As shown in FIGS. 10 to 13, the frame is fully folded.

As shown in FIGS. 10 to 13, when the frame needs to be unfolded, an external force is applied to the handle body 310 such that the handle support rod 320 is unfolded. As shown in FIGS. 6 to 9, the first handle portion 321 and the second handle portion 322 are pivoted and folded in a direction away from each other. The pivoting of the second handle portion 322 drives the second support assembly 600 to rotate. The first support assembly 500 and the second support assembly 600 are pivoted in a direction away from each other, and the guide member 910 is rotated from the second limit surface 912 abutting against the second abutting surface 812 to the first limit surface 911 abutting against the first abutting surface 811, such that the frame is fully unfolded.

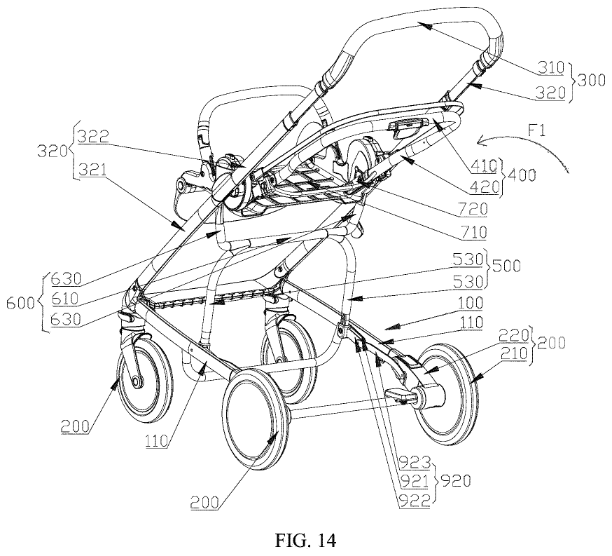

In a second embodiment, as shown in FIG. 14, in addition to the second cross rod portion 610, the second support assembly 600 includes two second support member 630 connected to two ends of the second cross rod portion 610 respectively. Ends of the two second support members 630 away from the second cross rod portion 610 are pivotably connected on the two handle support rods 320 respectively. The first support assembly 500 includes two first support members 530 that are arranged relative to each other.

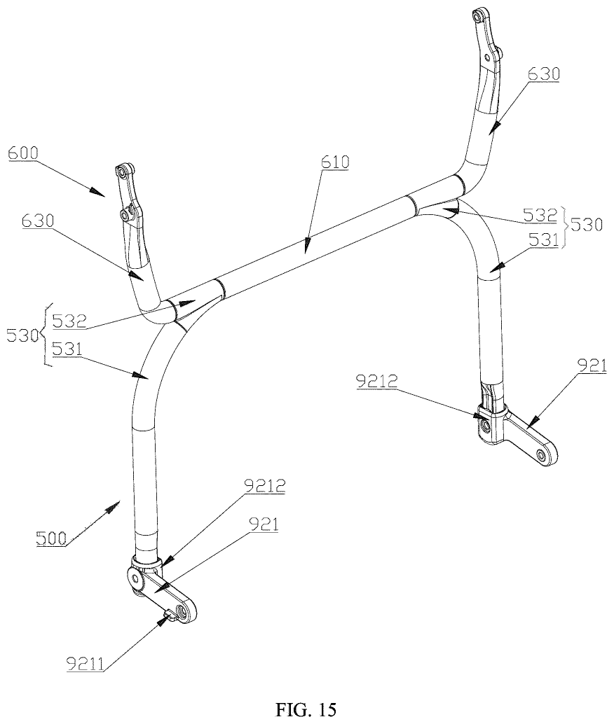

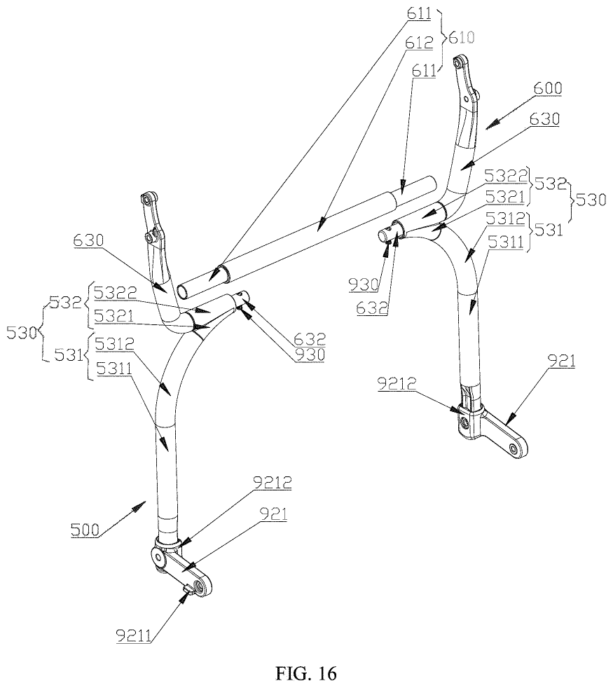

One of the first support members 530 is taken as an example to illustrate its structure and connection. As shown in FIGS. 14 to 16, the first support member 530 includes a first support rod 531 and a sleeve member 532 that are fixedly connected to each other. Specifically, the first support rod 531 includes a straight rod section 5311 and an arc-shaped rod section 5312. One end of the straight rod section 5311 is connected to one end of the arc-shaped rod section 5312, another end of the straight rod section 5311 is pivotably connected to the base support rod 110, and another end of the arc-shaped rod section 5312 is fixedly connected to the sleeve member 532. The sleeve member 532 includes a first sleeve cylinder 5321 and a second sleeve cylinder 5322 connected to each other. The second sleeve cylinder 5322 extends substantially along the left-right direction of the frame, and as shown in FIG. 14 and FIG. 15, the first sleeve cylinder 5321 is located below the second sleeve cylinder 5322 when the frame is fully unfolded. In this embodiment, the sleeve member 532 is an integrated molding structure made by injection molding or the like. In other embodiments, the sleeve member 532 may also be formed by butt fusion welding, welding, bonding, etc. of the first sleeve cylinder 5321 and the second sleeve cylinder 5322 which are independent of each other. The arc-shaped rod section 5312 is inserted at least partially in the first sleeve cylinder 5321 and is fixed to the first sleeve cylinder 5321. In this embodiment, the arc-shaped rod section 5312 is fixed to the first sleeve cylinder 5321 by a fastener 930 such as a screw, a rivet, a pin, etc.. In other embodiments, the arc-shaped rod section 5312 may also be fixed to the first sleeve cylinder 5321 by butt fusion welding, welding, bonding, etc..

Further, as shown in FIGS. 14 to 16, the second support assembly 600 has an overall U-shape rod structure, and the second support assembly 600 has a second cross rod portion 610 and a second support member 630 connected to two ends of the second cross rod portion 610, respectively. The second cross rod portion 610 has an overall straight rod structure and extends substantially along the left-right direction of the frame, with the first support assembly 500 rotatably connected to the second cross rod portion 610. The second cross rod portion 610 includes a support portion 612 and two second insertion portions 611 connected to two ends of the support portion 612. An outer radial dimension of the support portion 612 is larger than an outer radial dimension of either of the second insertion portions 611. In this embodiment, both the support portion 612 and the second insertion portion 611 are straight round rods, so an outer diameter of the support portion 612 is larger than an outer diameter of either of the second insertion portions 611. In this embodiment, the second cross rod portion 610 is an integrated molding structure made by injection molding or the like. In other embodiments, the second cross rod portion 610 may also be may also be formed by butt fusion welding, welding, bonding, etc. of the support portion 612 and two second insertion portions 611 which are independent of each other. In other embodiments, the support portion 612 and the second cross rod portion 611 may also be flat rods or other types of rods.

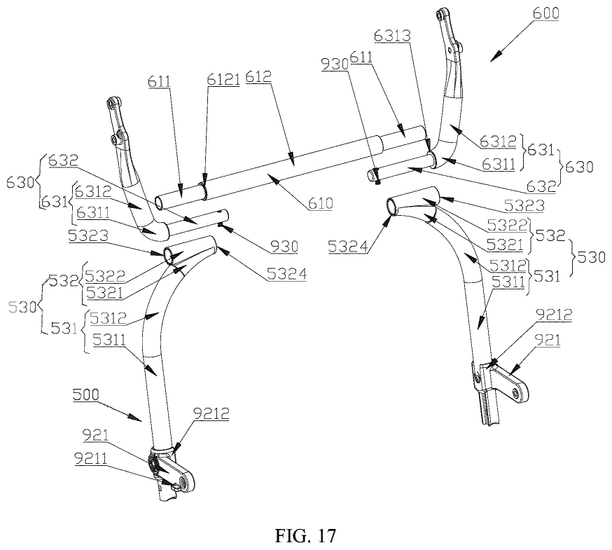

Specifically, the second support member 630 connected to one side of the second cross rod portion 610 is used as an example to explain its structure and connection relationship in detail. As shown in FIG. 17, the second support member 630 includes a second support rod 631 and a first insertion portion 632 that are connected to each other. The second support member 631 is a substantially L-shaped rod and the first insertion portion 632 is a substantially horizontal rod. The second support rod 631 includes a first rod 6311 and a second rod 6312 that are connected to each other and arranged at an angle. An end of the first rod 6311 away from the second rod 6312 is connected to the first insertion portion 632, and an outer radial dimension of the first rod 6311 is larger than an outer radial dimension of the first insertion portion 632. In this embodiment, the first rod 6311 and the first insertion portion 632 are both round rods, such that an outer diameter of the first rod 6311 is larger than an outer diameter of the first insertion portion 632. An end of the second rod 6312 away from the first rod 6311 is pivotably connected to the handle support rod 320. In other embodiments, the first rod 6311 and the first insertion portion 632 may also be flat rods or other types of rods.

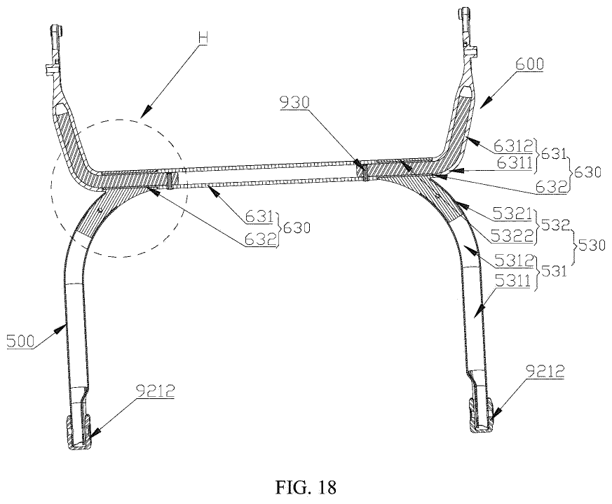

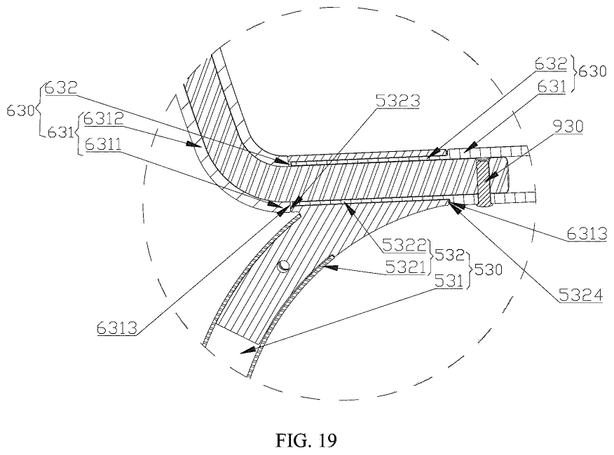

The first support member 530, the second support member 630 and the second insertion portion 611, which are located on a side of the support portion 612, are described below as an example. As shown in FIGS. 17 to 19, the first insertion portion 632 is at least partially inserted into the second sleeve cylinder 5322, and the second insertion portion 611 is at least partially inserted into the second sleeve cylinder 5322 and sleeved outside the first insertion portion 632. The first insertion portion 632 is fixedly connected to the second cross rod portion 610. In this way, the second cross rod portion 610 is rotatable relative to the second sleeve cylinder 5322, i.e., the second support assembly 600 is rotatable relative to the first support assembly 500.

Specifically, as shown in FIGS. 17 to 19, two ends of the second sleeve cylinder 5322 have a first stop end surface 5323 and a second stop end surface 5324, respectively. Since an outer diameter of the first rod 6311 is larger than an outer diameter of the first insertion portion 632, an end of the first rod 6311 connected to the first insertion portion 632 forms a third stop end surface 6313, and the third stop end surface 6313 is provided substantially along a radial direction of the first rod 6311. When the first insertion portion 632 is inserted in the second sleeve cylinder 5322, the third stop end surface 6313 abuts against the first stop end surface 5323, while an end of the first insertion portion 632 away from the first rod 6311 penetrates the second sleeve cylinder 5322 and be located on a side of the second stop end surface 5324 that is away from the first stop end surface 5323. Since an outer diameter of the support portion 612 is larger than an outer diameter of the second insertion portion 611, an end of the support portion 612 connected to the second insertion portion 611 forms a fourth stop end face 6121, which is disposed substantially in a radial direction of the support portion 612. When the second insertion portion 611 is inserted in the second sleeve cylinder 5322, the fourth stop end surface 6121 abuts against the second stop end face 5324. Meanwhile, the first insertion portion 632 protruding from the second sleeve cylinder 5322 is provided with a fastener 930 such as a screw, a pin or a rivet, and the support portion 612 is provided with a fastening hole (not shown in the figures), and the first insertion portion 632 and the support portion 612 are fixedly connected through the cooperation of the fastener 930 and the fastening hole.

In this way, during the rotation of the second cross rod portion 610 and second support member 630 relative to the second sleeve cylinder 5322, the third stop end surface 6313 is kept abutting against the first stop end surface 5323, and the fourth stop end surface 6121 is kept abutting against the second stop end surface 5324. In this way, the second support assembly 600 is guided and limited such that the second support assembly 600 rotates in a given direction, avoiding the second cross rod portion 610 or the gap between the second support member 630 and the sleeve member 532 from causing the second support assembly 600 to wobble from side to side. In this way, the structure stability of the frame can be further improved.

In this embodiment, as shown in FIGS. 15 to 17, an outer diameter of the first rod 6311, an outer diameter of the second sleeve cylinder 5322 and an outer diameter of the support portion 612 are substantially the same, such that the first rod 6311, second sleeve cylinder 5322 and support portion 612 form a straight round rod with uniform outer diameter after being assembled, which makes the frame as a whole more simple and more beautiful, and can avoid pinching the user. The Second support assembly 600 is assembled by the second cross rod portion 610 and two second support members 630, which can also reduce the difficulty of assembly to a certain extent. In the case of assembly conditions allow, the second support assembly 600 may also be an integrated molding U-shaped rod structure.

The first support assembly 500 and the second support assembly 600 in this embodiment are rotatably connected only by means of the sleeve cylinder 532 located at the ends of the second cross rod portion 610. The pivoting connection between the first support assembly 500 and the second support assembly 600 is a line connection, such that the second cross rod portion 610 provides better stability to the overall structure, while the rotating contact surface is relatively smaller, and therefore the rotating friction is lower.

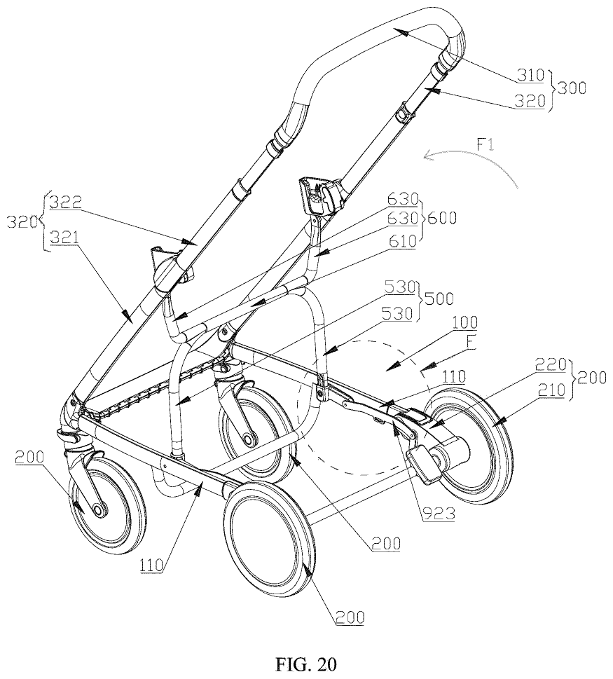

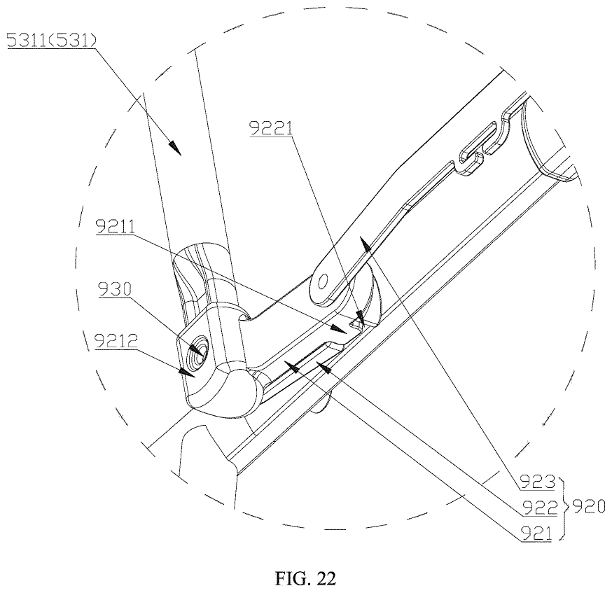

In this embodiment, as shown in FIGS. 20 to 22, the frame may also include a limit assembly 920 to limit the rotational stroke of the first support assembly 500. Specifically, the limit assembly 920 includes a first limit member 921, a second limit member 922, and a linking member 923. The first limit member 921 has a substantially rectangular sheet structure. An end of the first limit member 921 is fixedly connected to the first support assembly 500. Specifically, an end of the first support assembly 921 is formed into a fixing sleeve cylinder 9212, and the fixing sleeve cylinder 9212 is sleeved on an end of the first support rod 531 away from the sleeve member 532 and is fixedly connected to the first support rod 531 by a fastener 930 such as a screw, a pin or a rivet. The first limit member 921 is provided with a limit projection 9211 on a surface facing the base support rod 110. The linking member 923 has a substantially arc-shaped rod structure. One end of the linking member 923 is pivotably connected to an end of the first limit member 921 away from the first support rod 531, and another end of the linkage 923 is pivotably connected to the wheel fixing member 220. The second limit member 922 is substantially rectangular in shape and is fixed to the base support rod 110. The second limit member 922 is provided with a limit recess 9221 that can be engaged with the limit projection 9211. As shown in FIG. 22, the opening of the limit recess 9221 faces downward. In a process of switching the frame from a fully folded state to a fully unfolded state, the first support assembly 500 rotates in a first direction, and the second support assembly 600 rotates in a second direction opposite to the first direction, such that the first support assembly 500 and the second support assembly 600 are away from each other. In this way, when the frame is switched from the fully folded state to the fully unfolded state, the limit projection 9211 on the first support member 921 is engaged with the limit recess 9221 on the second limit member 922, which can restrict the first support assembly 500 from continuing to rotate in the first direction, which in this embodiment is to restrict the first support assembly 500 from continuing to rotate in the counter-clockwise direction, i.e., a direction of F1 in FIG. 20 (that is, a direction close to the front wheel assembly 200, while the second direction is a clockwise direction opposite to the direction of F1 in FIG. 20). In this way, the first support assembly 500 can be prevented from over-rotating and being locked when the frame is unfolded in place.

In other embodiments, it is also possible to reverse the arrangement by providing a limit recess 9221 on the first limit member 921 and a limit projection 9211 on the second limit member 922. Alternatively, the second limit member 922 can be omitted and a second limit portion such as a limit projection 9211 or limit recess 9221 can be provided directly on the base support rod 110, and a corresponding limit recess 9221 or a limit projection 9211 can be provided on the first limit member 921 that can be engaged with the second limit portion. Alternatively, the limit projection 9211 and the limit recess 9221 can be replaced with limit hooks and limit rings, etc.

In this embodiment, a limit assembly 920 is provided between the base support rod 110 and the first support rod 531 located on the left side and right side of the frame. In other embodiments, it is also possible to provide a limit assembly 920 between the base support rod 110 and the first support rod 531 on one side only.

Alternatively, a limit assembly 920 can be provided between the first connecting portion 520 and the base support rod 110 in the first embodiment to limit the rotational stroke of the first support assembly 500 in this embodiment, thereby facilitating the locking of the frame when it is unfolded in place.

In the second embodiment, the frame is folded or unfolded as follows.

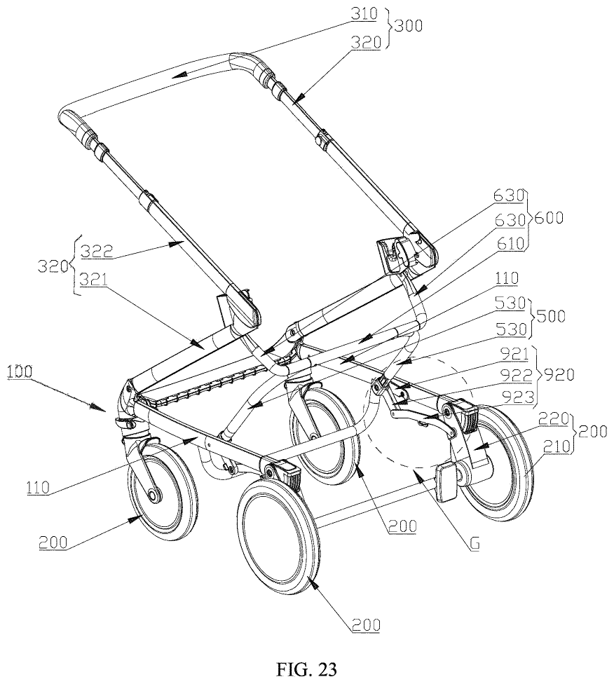

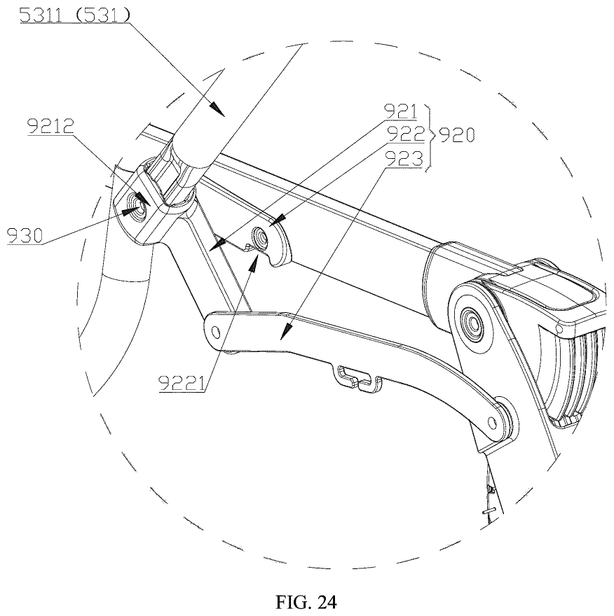

As shown in FIG. 14, when the frame needs to be folded, an external force is applied to the handle body 310, causing the handle support rod 320 to bend. As shown in FIG. 23, the first handle portion 321 and the second handle portion 322 are pivoted and folded in a direction close to each other. The pivoting of the second handle portion 322 drives the second support assembly 600 to rotate. The second support assembly 500 and the second support assembly 600 are also pivoted and folded in a direction close to each other. As shown in FIG. 24, during this process, the limit projection 9211 and the limit recess 9221 are disengaged, and the frame is completely folded.

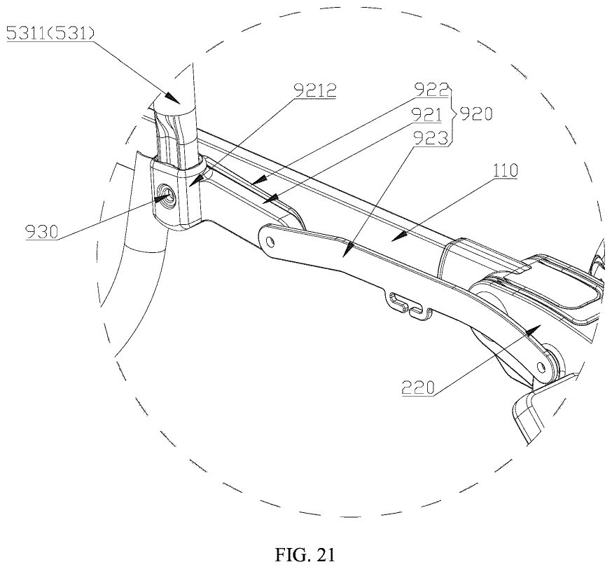

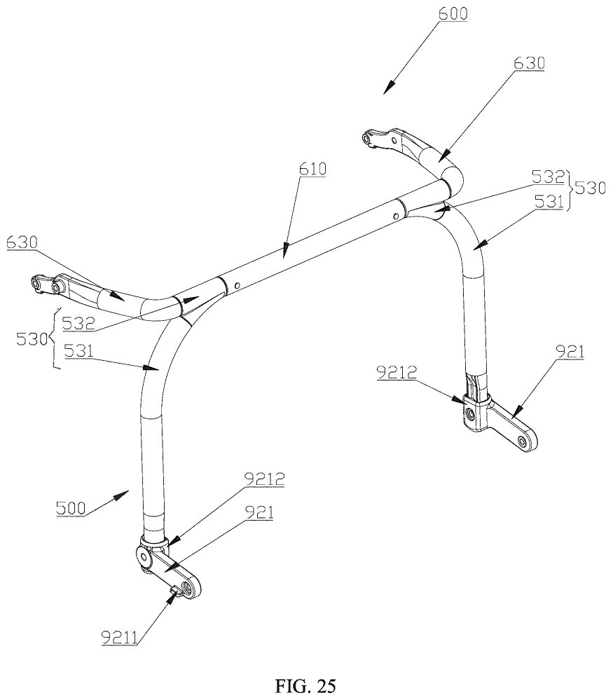

As shown in FIG. 23 and FIG. 25, when the frame needs to be unfolded, an external force is applied to the handle body 310, causing the handle support rod 320 to be unfolded. The first handle portion 321 and the second handle portion 322 are pivoted and folded in a direction away from each other. The pivoting of the second handle portion 322 drives the second support assembly 600 to rotate. The first support assembly 500 and the second support assembly 600 are also pivoted away from each other. In this process, the first limit member 921 moves in a direction close to the second limit member 922, such that the limit projection 9211 and the limit recess 9221 are re-engaged, and the frame is fully unfolded as shown in FIG. 20 and FIG. 21.

The aforementioned frame has at least the following beneficial effects:

In the aforementioned frame, the first support assembly 500 and the second support assembly 600, which are interconnected, are used as support structures to support the handle 300 and the base bracket 100. In this way, two ends of the first support assembly 500 are connected to the base support rod 110 respectively, and two ends of the second support assembly 600 are connected to the handle support rod 320, respectively, and the first support assembly 500 and the second support assembly 600 are connected to each other by a second cross rod portion 610. As a result, the stability is higher.

In the frame of the present disclosure, the first support assembly and the second support assembly connected to each other serve as a support structure for supporting a handle and a base bracket. Thus, two ends of the first support assembly are connected to the base support rod respectively, two ends of the second support assembly are connected to the handle support rod respectively, and a line connection between the first support assembly and the second support assembly is realized through the second cross rod portion. As a result, the stability is higher.

The frame provided in the present disclosure is capable of providing a stable support, and the overall structure is not easy to shake, and the riding experience is good.

The technical features of the aforementioned embodiments may be combined arbitrarily. To simplify the description, not all the possible combinations of the technical features in the aforementioned embodiments are described. However, all of the combinations of these technical features should be considered as within the scope of the present disclosure, as long as such combinations do not contradict with each other.

The aforementioned embodiments only represent several examples of the present disclosure, and the description thereof is more specific and detailed, but it should not be construed as restricting the scope of the present disclosure. It should be noted that, for those skilled in the art, several variations and improvements may be made without departing from the concept of the present disclosure, and these are all within the protection scope of the present disclosure. Therefore, the protection scope of the present disclosure shall be defined by the appended claims.

1. A frame, comprising:
two base support rods;
two handle support rods;
a first support assembly; and
a second support assembly, being U-shaped and comprising a second cross rod portion disposed along a left-right direction of the frame, the first support assembly being connected to the second cross rod portion;
wherein the first support assembly and the second support assembly are connected between the two base support rods and the two handle support rods.

2. The frame according to claim 1, wherein the first support assembly is rotatably connected to the second cross rod portion of the second support assembly, the first support assembly is pivotably connected to the two base support rods, and the second support assembly is pivotably connected to the two handle support rods.

3. (canceled)

4. The frame according to claim 1, wherein the first support assembly is U-shaped, the first support assembly comprises a first cross rod portion, the first cross rod portion is connected to the second cross rod portion and both are arranged in a left-right direction of the frame;
wherein the frame comprises a connection member sleeved outside the first cross rod portion and the second cross rod portion, the first cross rod portion is fixedly connected to the connection member, and the second cross rod portion is rotatable relative to the connection member.

5. (canceled)

6. (canceled)

7. (canceled)

8. The frame according to claim 4, wherein the connecting member comprises a first sleeve portion and a plurality of second sleeve portions, wherein the plurality of second sleeve portions are provided at intervals and are connected to the first sleeve portion, the first sleeve portion is sleeved outside the first cross rod portion, and the plurality of second sleeve portions are sleeved outside the second cross rod portion;
wherein the frame further comprises a guide member located between two adjacent second sleeve portions, the guide member is fixedly connected to the second cross rod portion, the guide member has a first limit surface and a second limit surface, the connection member has a first abutting surface and a second abutting surface, and the first abutting surface and the second abutting surface are both located on the first sleeve portion, and
wherein, when the frame is in a fully unfolded state, the first limit surface abuts against the first abutting surface, and when the frame is in a fully folded state, the second limit surface abuts against the second abutting surface.

9. The frame according to claim 4, wherein the connecting member comprises a first sleeve portion and a plurality of second sleeve portions, wherein the plurality of second sleeve portions are provided at intervals and are connected to the first sleeve portion, the first sleeve portion is sleeved outside the first cross rod portion, and the plurality of second sleeve portions are sleeved outside the second cross rod portion;
wherein the frame further comprises a guide member located between the two adjacent second sleeve portions, the guide member is fixedly connected to the second cross rod portion, the guide member has a first guide surface and a second guide surface, the connection member has a third abutting surface and a fourth abutting surface, and the third abutting surface and the fourth abutting surface are two opposing surfaces of the two adjacent second sleeve portions respectively, and
wherein during a rotation of the second cross rod portion, the first guide surface is kept abutting against the third abutting surface, and the second guide surface is kept abutting against the fourth abutting surface.

10. (canceled)

11. (canceled)

12. The frame according to claim 1, wherein the first support assembly comprises two first support members, and the two first support members are connected to two ends of the second cross rod portion, respectively;
wherein the first support assembly, and in particular the first support member, comprises a first support rod and a sleeve member, wherein the sleeve member is fixedly connected to the first support rod, and the sleeve member is sleeved outside the second cross rod portion; and
wherein the second support assembly further comprises two second support members fixed to two ends of the second cross rod portion.

13. The frame according to claim 1, wherein the first support assembly comprises two first support members, and the two first support members are connected to two ends of the second cross rod portion, respectively;
wherein the first support assembly, and in particular the first support member, comprises a first support rod and a sleeve member, wherein the sleeve member is fixedly connected to the first support rod, and the second cross rod portion is rotatable relative to the sleeve member; and
wherein the second support assembly further comprises two second support members fixed to two ends of the second cross rod portion.

14. (canceled)

15. The frame according to claim 12, wherein each of the two second support members comprises a first insertion portion, and wherein the first insertion portions of the two second support members are at least partially inserted into the two sleeve members, respectively

16. The frame according to claim 15, wherein the second cross rod portion comprises a support portion and two second insertion portions, wherein two ends of the support portion are connected to the two second insertion portions, respectively, and the two second insertion portions are at least partially inserted in the two sleeve members and sleeved outside the two first insertion portions.

17. The frame according to claim 16, wherein an outer radial dimension of the support portion is greater than an outer radial dimension of any of the second insertion portions.

18. The frame according to claim 15, wherein the second support assembly further comprises a fastener that fixedly connects the first insertion portion to the support portion of the second cross rod portion.

19. The frame according to claim 15, wherein the second support member further comprises a second support rod being L-shaped and comprising a first rod and a second rod which are connected to each other and arranged at a certain angle, and
wherein an end of the first rod away from the second rod is connected to the first insertion portion, and an outer radial dimension of the first rod is larger than an outer radial dimension of the first insertion portion.

20. The frame according to claim 1, further comprising a first limit member and a second limit member, wherein the first limit member is connected to the first support assembly, the second limit member is connected to the base support rod, and wherein, in a process of switching the frame from a fully folded state to a fully unfolded state, the first support assembly rotates in a first direction, and the second support assembly rotates in a second direction opposite to the first direction, such that the first support assembly and the second support assembly are away from each other, and wherein, when the frame is switched to a fully unfolded state, the first limit member is engaged with the second limit member to restrict the first support assembly from rotating in the first direction.

21. The frame according to claim 20, wherein one of the first limit member and the second limit member has a limit recess, and the other of the first limit member and the second limit member is a limit projection that is engageable with the limit recess.

22. The frame according to claim 20, further comprising a linking member and a wheel fixing member, wherein the wheel fixing member is connected to the base support rod, one end of the first limit member is fixedly connected to the first support assembly, another end of the first limit member is pivotably connected to one end of the linking member, and another end of the linking member is pivotably connected to the wheel fixing member.

23. The frame according to claim 1, further comprising a first limit member and a second limit portion, wherein the first limit member is connected to the first support assembly, the second limit portion is connected to the base support rod, and wherein, in a process of switching the frame from a fully folded state to a fully unfolded state, the first support assembly rotates in a first direction, and the second support assembly rotates in a second direction opposite to the first direction, such that the first support assembly and the second support assembly are away from each other, and wherein, when the frame is switched to the fully unfolded state, the first limit member is engaged with the second limit portion to restrict the first support assembly from rotating in the first direction.

24. The frame according to claim 23, wherein the first limit member has a limit projection, and the second limit portion is a limit recess provided on the base support rod; or
wherein the first limit member has a limit recess, and the second limit portion is a limit projection provided on the base support rod.

25. The frame according to claim 1, wherein the first support assembly is connected to the two base support rods, and two ends of the second support assembly are connected to the two handle support rods, respectively; or
wherein the first support assembly is connected to the two handle support rods, and two ends of the second support assembly are connected to the two base support rods respectively.

26. The frame according to claim 1, further comprising a seat plate, two backrest support rods and two connecting rods, wherein the two connecting rods are connected to the two backrest support rods, respectively, and two sides of the seat plate are fixed on the two connecting rods or the two backrest support rods, respectively.

27. (canceled)

28. The frame according to claim 1, wherein the handle support rod comprises a first handle portion and a second handle portion which are pivotably connected to each other, wherein an end of the first handle portion away from the second handle portion is fixed to the base support rod, and two ends of the second support assembly are pivotably connected to the second handle portions of the two handles support rods, respectively.
